(19) United States
(12) Patent Application Publication
(10) Pub. No.: US 2023/0305608 A1
(43) Pub. Date: Sep. 28, 2023

(54) DEVICE-INTERNAL CLIMATE CONTROL FOR HARDWARE PRESERVATION

(71) Applicant: Microsoft Technology Licensing, LLC, Redmond, WA (US)

(72) Inventor: Raymond-Noël N KONO, Snoqualmie, WA (US)

(21) Appl. No.: 17/702,290

(22) Filed: Mar. 23, 2022

(51) Int. Cl. G06F 1/20; G06F 9/48

(52) U.S. Cl. CPC G06F 1/20; G06F 9/4856; G05B 2219/49216

(57) ABSTRACT

A processing device executes a climate control system to protect its hardware elements from damage due to adverse environmental conditions. The processing device executes logic for self-determining a device-internal environmental condition and for initiating a workload on the processing device responsive to determining that the device-internal environmental condition satisfies predefined criteria indicative of a hardware safety risk.

### BACKGROUND

Certain environmental conditions can present a risk to processing devices, such as servers and storage drives. For example, condensation can cause corrosion of metal components or create undesired conductive paths that create electrical shortages and cause device failure. Likewise, extreme cold/heat may cause different types of materials, such as plastics and metals, to contract/expand at different rates, potentially causing cracking. Electronic device storage centers, such as cloud data centers, typically utilize building-managed climate control, such as central heating and conditioning systems to protect equipment. However, climate control systems can be expensive to operate in terms of power.

In some scenarios, climate control systems fail to prevent environmental elements from damaging electronic equipment. If, for example, power is lost in a data storage facility during a time when temperatures and humidity are high, humidity and temperature within the data storage facility may rise to levels that present a high risk of condensation. In this case, if the temperature is suddenly lowered (such as when the power is restored and the AC turns on), condensation may form on sensitive electronic surfaces as a result. Likewise, failure of a heating system in a particularly cold-climate facility (e.g., a satellite or submarine) can present a risk of equipment damage. In these and other scenarios, existing climate control systems may be inadequate.

### SUMMARY

According to one implementation, a disclosed method provides for determining a device-internal environmental condition for a processing device and for initiating a workload on the processing device responsive to determining that the device-internal environmental condition satisfies predefined criteria indicative of a hardware safety risk.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that includes a processing device with local climate awareness and local climate control capabilities.

FIG. 2 illustrates an example processing device that self-implements actions for local climate control to self-protect internal hardware from damage due to adverse environmental conditions.

FIG. 3 illustrates an example processing center with a number of processing devices that each execute aspects of a local climate monitoring and control system.

FIG. 4 illustrates example processing operations for local climate control within a processing device.

FIG. 5 illustrates an example schematic of a processing device suitable for implementing aspects of the disclosed technology.

### DETAILED DESCRIPTION

The herein disclosed technology provides a device-managed climate control system that equips a processing device with climate-awareness and localized climate control capability such that the device may autonomously detect adverse conditions that present a risk to internal hardware of the device and, in response, self-initiate actions to protect that hardware. According to one implementation, the processing device performs actions to affect local climate control utilizing a same set of hardware and control signals that are used to conduct nominal operations for the device.

As explained above, a power outage in a data storage facility during a time of high heat and humidity can pose a risk of condensation at the time that power is restored and air conditioning (AC) is turned on. However, if a processing device is executing a workload when the AC turns on, the workload generates local heat within the processing device that keeps the processing device warm and dry even if condensation forms on elsewhere in the same room while the AC system is working to cool the room remove moisture from the air. According to one implementation, a processing device implementing the disclosed technology self-initiates a workload in response to detecting adverse environmental changes that may pose a hardware safety risk The workload locally generate heat that protects the processing device for a period of time until the risk of hardware damage is eliminated.

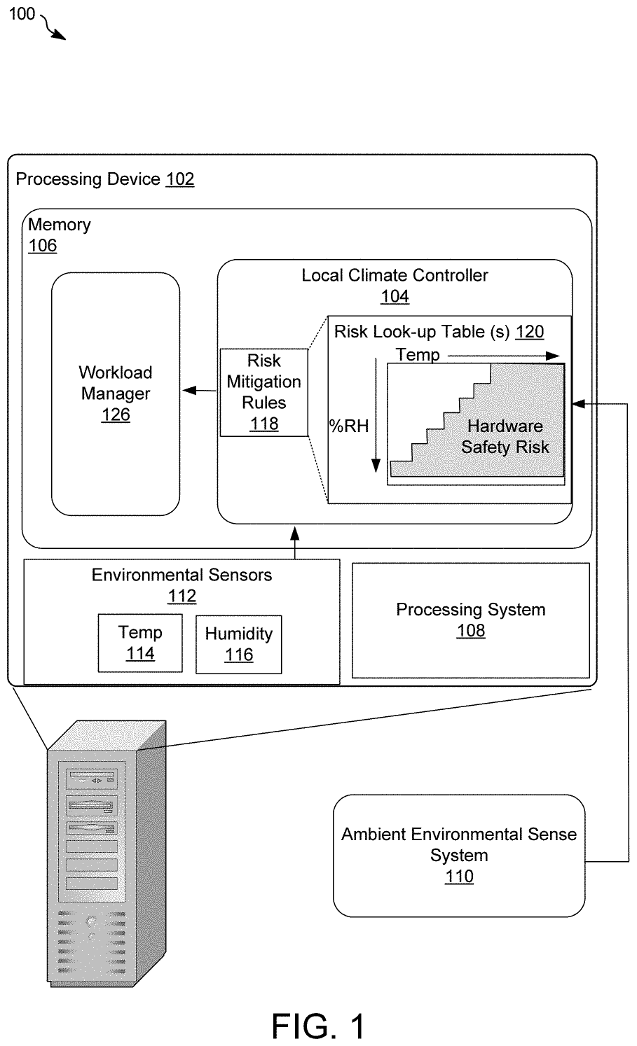

FIG. 1 illustrates an example system 100 that includes a processing device 102 with local climate awareness and local climate control capabilities. The processing device 102 is shown to be a server but may, in various implementations, be any electronic device with memory 106 and a processing system 108. The processing system 108 may include a single processor (e.g., a microprocessor) or multiple different processors serving different purposes within the processing device 102.

In FIG. 1, the processing device 102 also includes one or more environmental sensors 112 that are capable of measuring aspects of an environment internal to the processing device 102. The environmental sensors 112 are, in general, capable of detecting device-internal environmental condition(s) that may be indicative of a hardware safety risk. A hardware safety risk presents a risk of hardware damage, such as conditions that may cause materials to crack or warp and/or shorting of electrical circuits that may cause electrical components to overheat, melt, or break. Examples of detectable conditions that may present a hardware safety risk include extreme temperatures and/or conditions favorable to the formation of condensation (e.g., high temperature combined with high relative humidity). Although different implementations of the disclosed technology may employ different types of the environmental sensors 112, the processing device 102 of FIG. 1 is shown to include a temperature sensor 114 and a humidity sensor 116. Both temperature and humidity are critical indicators of condensation risk. Likewise, a temperature measurement is indicative of the extreme hot and/or cold conditions that may damage hardware.

The system 100 may, in some implementations, include an ambient environmental sense system 110 with one or more ambient environmental sensor(s) (e.g., a temperature sensor, relative humidity sensor) and communications circuitry for transmitting measurements collected by the ambient environmental sensor(s) to the processing device 102. The ambient environmental sense system 110 is positioned at a location external to the processing device 102 but still within a same general environment, such as a same room or building. Measurement collected by the ambient environmental sensors of the ambient environmental sense system 110 may be used by the processing device 102 to assess current conditions of the ambient environment surrounding the processing device 102.

Sensor data collected by the environmental sensors 112 and/or the ambient environmental sense system 110 is provided to a local climate controller 104 that is stored in the memory 106 and executed by the processing system 108 of the processing device 102. The local climate controller 104 performs various actions for assessing the hardware safety risk that may be posed by adverse environmental conditions. In general, the local climate controller 104 utilizes the received and/or locally-collected sensor data to determine whether presently-detected environmental conditions satisfy predefined criteria indicative of a hardware safety risk. In one implementation, the predefined criteria are satisfied when a detected temperature internal to the device exceeds a first threshold at the same time that a detected relative humidity exceeds a second threshold (e.g., conditions conducive to formation of condensation). In another implementation, the predefined criteria are satisfied when the internal temperature of the device drops below a setpoint (e.g., so cold that the device may crack). For devices at risk of damage due to high heat, the predefined criteria may be satisfied when the internal temperature of the device exceeds a set threshold. When the hardware safety risk is high (e.g., the detected device-internal or ambient environmental conditions satisfy predefined criteria), the local climate controller 104 initiates a climate control action to help mitigate the risk of hardware damage.

In one implementation, the local climate controller 104 implements the climate control action selectively in accordance with risk mitigation rules 118 that set forth predefined criteria that, when satisfied by the locally-detected environmental conditions and/or ambient environmental conditions, indicate a significant risk of hardware damage. For example, a risk of condensation may be deemed significant enough to warrant protective action when a detected temperature exceeds a first threshold while a detected relative humidity exceeds a second threshold.

By example and without limitation, the risk mitigation rules 118 are shown to be based on information in a look-up table 120 that correlates hardware safety risk with various relative humidity and temperature readings. For example, the look-up table 120 may correlate each pair of temperature and relative humidity values with a binary metric indicating the existence or non-existence of a hardware safety risk. In other implementations, the risk mitigation rules 118 may provide computer-executable instructions for computing a relative degree of risk, such as “80% risk of hardware damage.” When the risk satisfies a given threshold, the hardware safety risk is deemed sufficient enough to initiate the climate control action.

When the detected device-internal and/or ambient environmental conditions satisfied the predefined criteria, the local climate controller 104 transmits a workload initiation command to a workload manager 126 that is also stored in the memory 106 and executed by the processing system 108 of the processing device 102. In response to receipt of the workload initiation command, the workload manager 126 selects a “climate control workload” and immediately causes the processing system 108 to begin executing the selected climate control workload. As used herein, a “climate control workload” is a workload that is executed for the primary purpose of generating heat to warm and dry the local environmental within (e.g., internal to) the processing device 102. Although the climate control workload may be a workload that performs some meaningful work, the climate control workload is—in one implementation—a non-critical workload. As used herein, “non-critical workload” may refer to a workload that does not modify user data stored within the processing device. By executing a non-critical workload to warm and dry the processing device 102, user data is less likely to be corrupted in the unlikely event that adverse environmental conditions do cause hardware damage. A non-critical workload may, for example, be a health and safety check process routinely executed by the device operating system or baseboard management controller, a calibration process, or a dummy workload that does not perform any meaningful compute work.

In one implementation, the local climate controller 104 actively monitors the environment internal to the processing device 102 by repeatedly sampling the local temperature and relative humidity levels using the environmental sensors 112. If the sampled sensor value(s) satisfy predefined criteria indicative of a hardware safety risk, the local climate controller 104 may transmit a command to the ambient environmental sense system 110 to retrieve ambient environmental conditions usable to confirm whether or not the hardware safety risk is real (or, alternatively, based on bad data). If, for example, the environmental sensors 112 detect a relative humidity and temperature that collectively satisfy the predefined criteria set forth by the risk mitigation rules 118 (e.g., criteria indicative of a hardware safety risk), the local climate controller 104 may request data indicative of the corresponding ambient environmental conditions (temperature, relative humidity) to confirm that detected conditions internal to the processing device 102 satisfy a threshold level of similarity with corresponding ambient conditions measured by the ambient environmental sense system 110. For example, the threshold level of similarity may be satisfied when the condition(s) detected internal to the processing device 102 are within +/−10% of the corresponding ambient environmental condition(s) detected by the environmental sensors 112.

Provided that the ambient environmental conditions are sufficiently similar to the device-internal environmental conditions, the risk is deemed to be real and the climate control workload is initiated to locally warm the processing device 102.

If the processing device 102 is being locally warmed, the air within the device holds moisture better and therefore provides the processing device 102 with some level of protection from condensation. This holds true even if an air conditioning (AC) system is turned on to cool the room or facility storing the processing device 102, such as in a scenario where the room or facility loses power for a period of time long enough for the internal air to creep to dangerous heat and humidity levels. If the climate control workload is executing on the processing device 102 while the AC system is working to cool and dry out the surrounding indoor area, the local temperature within the processing device 102 is kept high enough to prevent the condensation from occurring locally even if condensation occurs elsewhere in the ambient environment during this cooling process.

Consistent with the above, execution of the climate control workload may similarly protect the processing device 102 from hardware damage that is due to extreme cold. For example, temperatures 10 degrees Celsius may cause cracking within an electronic device due to uneven contraction of various device components. Although rare, there do exist certain use conditions where this risk is prevalent such as processing devices that are on satellites in space, deep-sea submarines, and potentially research facilities in artic environments. If a primary heat source fails in such an environment at a time when power is still provided to the processing device 102, the processing device 102 could potentially execute a climate control workload to generate local heat and protect its own hardware components.

In different implementations, aspects of the climate control workload may vary. For a large data facility, the execution of a climate control workload on many devices at once could consume significant power resources at high cost; therefore, the climate control workload may, in some implementations, be a workload that is selected and/or designed to mitigate total power consumption while still providing sufficient local warming to protect the processing device 102. “Sufficient” local warming depends on many factors including the expected operating conditions in the facility storing the processing device 102. Therefore, the climate control workload may in some implementations be selected based on the geographical climate in which the facility is located and/or based on the specific values of the environmental condition(s) detected by the environmental sensors 112. For instance, the workload manager 126 may dynamically select the climate control workload from a look-up table based on factors such as geographical location (as indicated by a user-provided setting, IP address, etc.) and/or based on the temperature and humidity values detected.

In one implementation, the ambient environmental sense system 110 includes a moisture sensor and can therefore detect condensation and inform the local climate controller 104 when moisture is detected in the ambient environment. The local climate controller 104 may use this feedback as a form of reinforcement learning to modify the risk mitigation rules 118 over time to more accurately define the specific environmental conditions that cause water droplets to condense on surfaces. Better tuning of these rules may help to limit the scenarios in which the climate control workload is executed, ultimately conserving power.

In one implementation, the local climate controller 104 repeatedly queries the ambient environmental sense system 110 with a request for updated ambient environmental sensor data, such as at regular intervals, while the climate control workload is executing. When the updated ambient environmental sensor data indicates that the hardware safety risk no longer exists (e.g., the environmental conditions no longer satisfy the predefined criteria), the local climate controller 104 instructs the workload manager 126 to terminate the climate control workload. In instances when the climate control workload executes to completion, the local climate controller 104 may, upon completion of the climate control workload, re-assess ambient environmental conditions to determine whether the hardware safety risk is ongoing. Provided that the hardware safety risk is indeed ongoing, the local climate controller 104 may instruct the workload manager 126 to restart the climate control workload, thereby extending the duration of local climate protection that is provided.

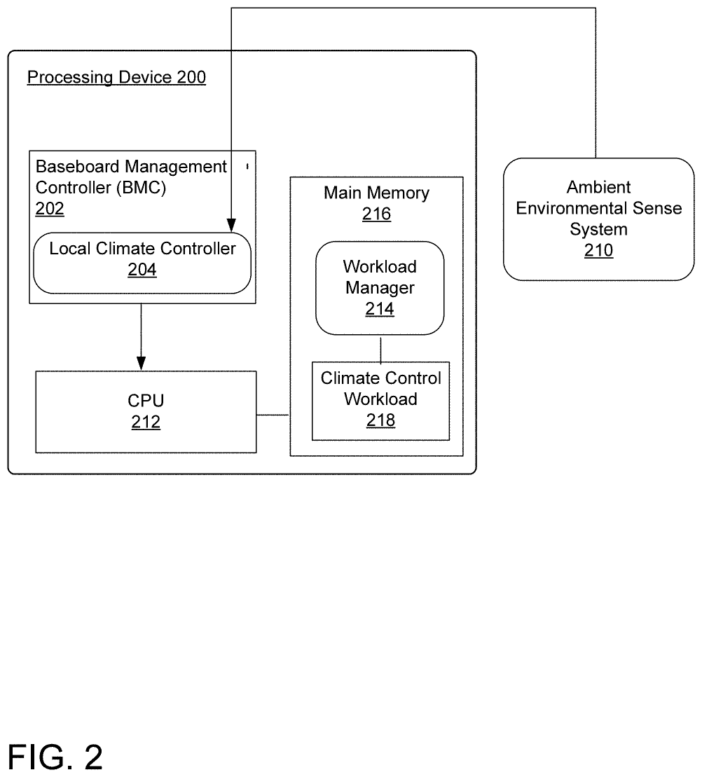

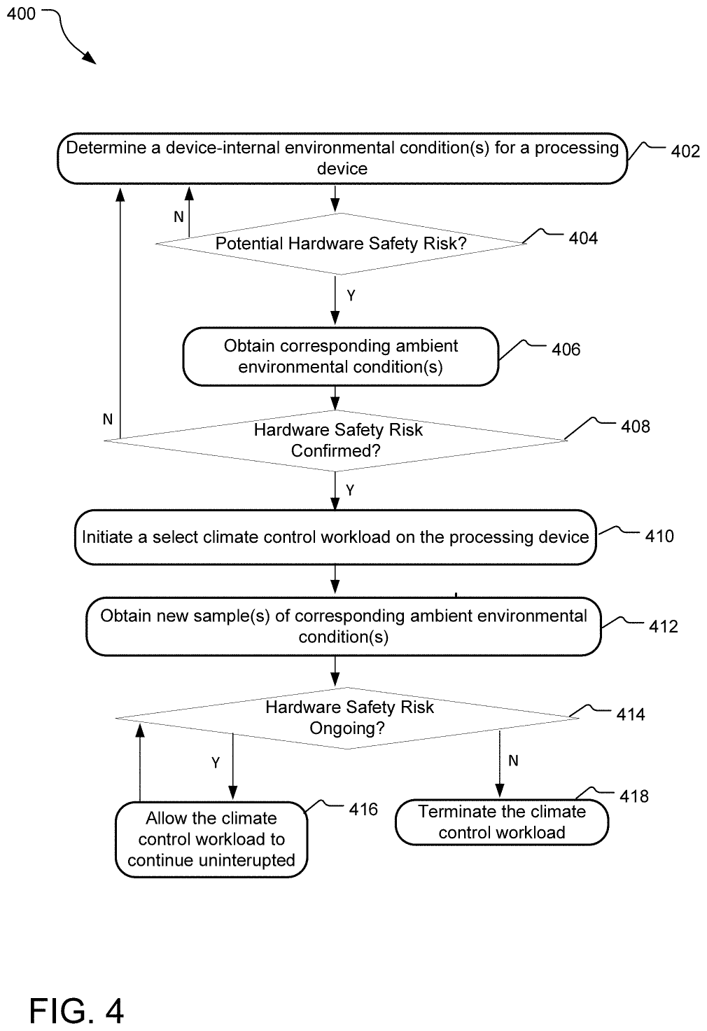

FIG. 2 illustrates an example processing device 200 that self-implements actions for local climate control to self-protect internal hardware from damage due to adverse environmental conditions. The processing device 200 is, for example, a server or other electronic device with memory, processing capability, and electric components that generate heat. The processing device 200 includes a baseboard management controller (BMC) 202 that monitors the physical state of the processing device 200 and that includes sensors to measure internal physical variables such as temperature, humidity, power-supply voltage, fan speeds, and operating system functions. In addition to executing firmware for monitoring a variety of health and safety parameters, the BMC 202 executes a local climate controller 204 (e.g., as firmware) that performs functions the same or similar to the local climate controller 204 described above with respect to FIG. 4.

Specifically, the local climate controller 204 monitors temperature and/or relative humidity internal to processing device 200 and at times, may request and receive ambient environmental data from sensors that are located within an ambient environmental sense system 210 external to processing device 200. When detected environmental conditions satisfy predefined criteria indicative of a hardware safety risk, the BMC 202 may transmit a command to a primary system processor (CPU 212) that instructs workload manager 214 stored in main memory 216 to selectively execute a climate control workload 218. The climate control workload 218 is, for example, a non-critical workload, a dummy workload, or a combination of workloads (e.g., low overhead apps that may run without modifying using data).

When the local climate controller 204 is managed by the BMC 202, as shown, the CPU 212 is freed up to perform nominal processing tasks; consequently, the monitoring activities of the local climate controller 204 do not affect CPU availability or otherwise reduce uptime or performance of the processing device 200 for nominal operations.

In another implementation, monitoring activities of the local climate controller 204 are implemented by low-overhead CPU commands rather than firmware of the BMC 202.

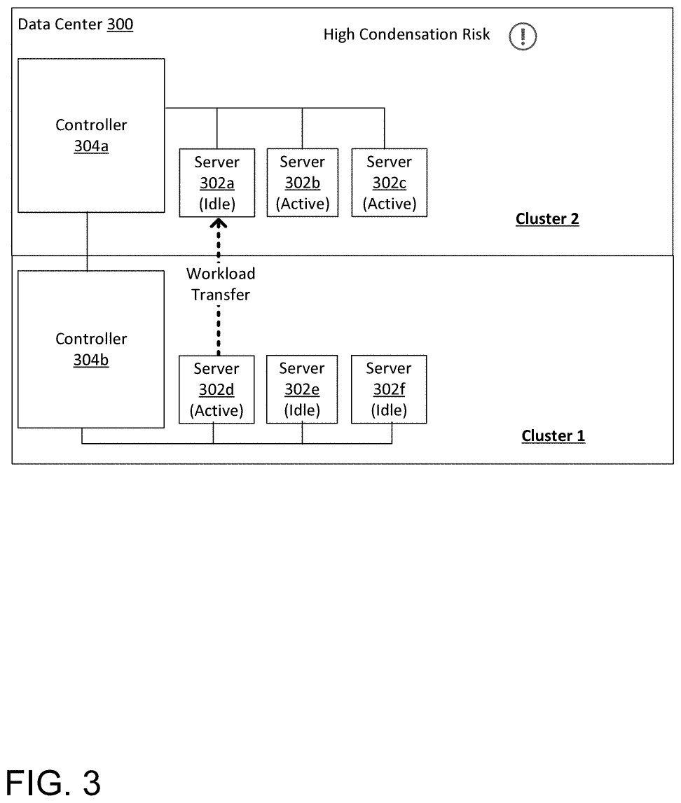

FIG. 3 illustrates an example data center 300 with processing devices (e.g., controllers 304a, 304b and servers 302a-302f) that execute aspects of a local climate monitoring and control system to prevent hardware damage due to adverse environmental conditions, such as condensation and extreme cold temperatures.

In the illustrated implementation, the data center 300 is networked such that servers on different clusters are locally coupled to different controllers 304a, 304b which may be, for example, chassis or rack-level controllers. In the illustrated example, it is presumed that each of the controllers 340a, 304b performs scheduling actions to direct and manage workloads among an associated subset of the servers 302a-302c or 302d-302f in the data center 300. Specifically, the controller 304a controls workload scheduling with respect to the servers 302a-302c, all of which are located on a second cluster in the data center 300 while the controller 304b controls workload scheduling with respect to the servers 302d-302f, all of which are located on the first cluster in the data center 300. It may be assumed that the first cluster (Cluster 1) and the second cluster (Cluster 2) are located in different physical regions of the data center 300 where the local environmental conditions are different, such as in different rooms or on different floors. The controllers 304a and 304b are connected over a local area network such that they can freely communicate with one another and share information about the various processing tasks being executed on each of the associated subsets of servers 302a-302c and 302d-302f.

In one implementation, each of the servers 302a-302f includes one or more device-internal environmental sensors, such temperature and/or humidity sensors. Each of the servers 302a-302f also individually executes aspects of a local climate controller (e.g., the local climate controller 104 of FIG. 1) by monitoring data collected by the associated device-internal environmental sensors to determine when the associated device-internal environmental conditions satisfy predefined criteria indicative of hardware safety risk.

In the example of FIG. 3, one or more of the servers 302a-302c on the second cluster of the data center 300 detects adverse environmental conditions (e.g., high levels of heat and humidity) and determines that the detected adverse environmental conditions present a hardware safety risk. At the time that the hardware safety risk is identified, two of the three servers on the second cluster are active (servers 302b, 302c) and a third server (server 302a) is idle. Because the active servers 302b, 302c are locally executing workloads that generate head and remove moisture from the air, the local climate controllers executing on such devices do not take action. In contrast, the local climate controller of the server 302a transmits a request for a climate control workload to the controller 304a. In response, the controller 304b identifies a suitable workload that may be transferred from another server in the data center 300 to the server 302a in order to locally alter the climate of the server 302a (by generating heat) and thereby mitigate the hardware safety risk for the server 302a. In this example, the climate control workload ultimately executed on the at-risk device (server 302a) is selected from a set of processes currently queued up for execution and/or currently executing on servers within the data center 300.

For example, the controller 304a communicates with the controller 304b to determine that (1) the servers 302d-302f on the first cluster are not experiencing the same adverse environmental conditions as the servers on the second cluster; and (2) to identify one or more active workloads or queued-up workloads (assigned but not yet started) that may be transferred from active server(s) on the first cluster to idle server(s) on the second cluster. The forgoing scenario may arise when, for example, a cooling system fails on the second cluster of the data center 300, allowing heat and relative humidity to rise to dangerous levels without substantially altering the heat and relative humidity on the first cluster. In this scenario, the controller 304b may selectively transfer an active workload from a select active server (e.g., server 302d) on the first cluster to the server 302a that is idle on the second cluster and at risk of water damage due to condensation that is likely to occur if and/when the second floor begins cooling. Responsive to the workload transfer, the server 302a executes the reallocated workload and is, consequently, locally warmed and temporarily protected by the localized heat from the condensation that may be forming on other device surfaces on the second floor while the cooling system is brought back online.

Transferring workloads among various networked processing devices may be feasible and beneficial in limited instances where adverse environmental conditions are localized such that fewer than all of the networked processing devices are affected by the adverse environmental conditions. Notably, the above-described reallocation of workload(s) could be implemented as described above by centralized control entities (e.g., the controllers 304a, 304b or a host device) or, alternatively, by way of direct node-to-node connections between the individual processing devices (servers 302a-302f). In latter scenario, the servers 302a-302f communicate directly with one another to share locally-detected environmental condition data and to reallocate workloads among themselves such that active devices in low-risk environments offload their respect workloads to idle devices in high-risk environments or in different regions.

If execution of the climate control workload affects modification of user data (e.g., the workload is critical), a hardware failure could inadvertently result in damage to the user data. Thus, the use of a critical workload as the climate control workload may introduce an element of risk. On the other hand, the use of a critical workload as the climate control workload also reduces overall overhead and power consumption of the above-described climate control action since local climate control is realized without executing new workloads in addition to those already queued up. Consequently, power consumption levels may remain steady in the data center 300 before, during, and after the protective climate control action.

FIG. 4 illustrates example processing operations 400 for local climate control within a processing device. A determining operation 402 determines one or more device-internal environmental condition(s) for a processing device, such as based on environmental sensors of the device or from other sensors in close proximity to the processing device. An evaluation operation 404 evaluates the device-internal environmental conditions in view of predefined criteria to determine whether such conditions are indicative of a potential hardware safety risk. The predefined criteria may, for example, set forth pairs of temperature and relative humidity readings that, in combination, satisfy the predefined criteria and indicate a potential hardware safety risk (e.g., high risk of condensation). In other implementations, the predefined criteria identify individual temperatures or relative humidity levels that, when observed in isolation, are indicative of a potential hardware safety risk.

If the potential hardware safety risk is not identified, the determination operation 402 may be repeated (e.g., new data is sampled and assessed after an interval of time has elapsed). On the other hand, if the potential hardware safety risk is identified, a data collection operation 406 obtains ambient environmental sensor data for a data integrity verification operation. A determination operation 408 confirms the existence of the hardware safety risk by comparing the ambient environmental sensor data to the device-internal environmental data previously collected for the processing device. If the determination operation 408 determines, from the comparison, that the ambient environmental conditions are substantially different from the device-internal environmental conditions (for example, more than +/−10% different and/or different enough that the ambient environmental conditions do not satisfy the predefined criteria indicative of the hardware safety risk), the determination operation 408 fails to confirm the hardware safety risk and the determination operation 402 is repeated. Otherwise, if the ambient environmental conditions are sufficiently similar to the device-internal environmental conditions (e.g., within +/−10% of agreement or other predefined threshold), the hardware safety risk is confirmed as a real threat.

Once the hardware safety risk is confirmed, a workload initiation operation 410 initiates a select climate control workload on the processing device. The climate control workload is, for example, a non-critical workload, a dummy workload, or other workload transferred from a networked device that is not currently experiencing the same hardware safety risk (e.g., as in the example discussed with respect to FIG. 3). While the climate control workload is executing on the processing device, another data collection operation 412 obtains new samples of the ambient environmental data to enable a reassessment of the ambient environmental conditions. A determination operation 414 assesses the newly sampled ambient environmental data in view of the predefined criteria to confirm whether the hardware safety risk remains ongoing.

If the determination operation 414 determines that the hardware safety risk has been eliminated (e.g., as evidenced by detected changes in the ambient environmental conditions), a termination operation 418 terminates the climate control workload. Otherwise, if the hardware safety risk is ongoing, a continuation operation 416 allows the climate control workload to continue executing. At such time that the climate control workload is forcibly terminated by termination operation 418 or otherwise reaches its natural end, the processing operations 400 may be repeated to effective re-executing the climate control workload one or more times up until such time that the hardware safety risk is resolved.

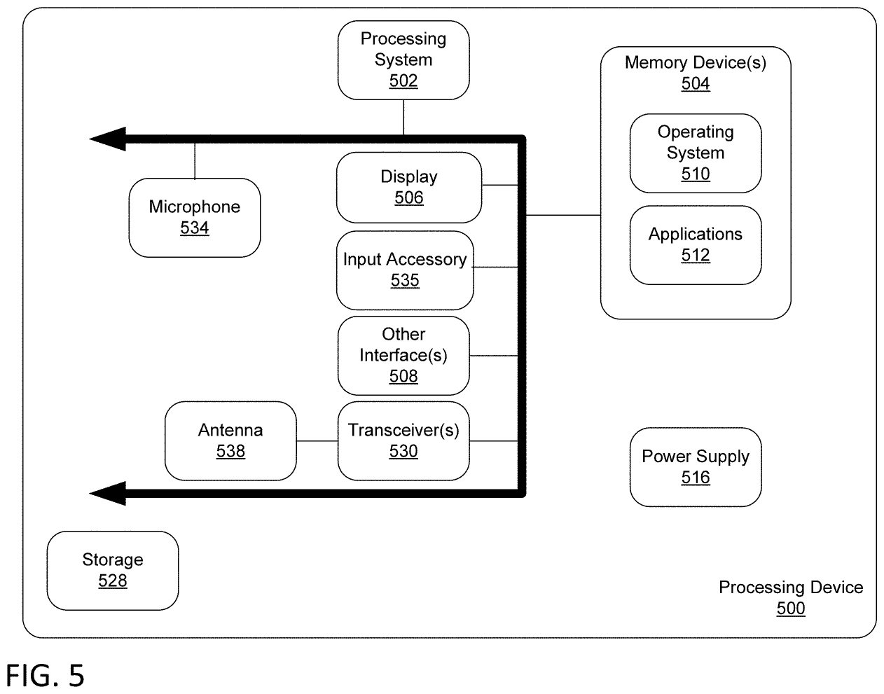

FIG. 5 illustrates an example schematic of a processing device 500 suitable for implementing aspects of the disclosed technology. In one implementation, the processing device 500 is a server that executes a local climate controller (e.g., the local climate controller 104 of FIG. 1) to monitor device-internal environmental conditions and to perform selective climate control actions to protect its respective hardware components from damage due to adverse environmental conditions.

The processing device 500 includes a processing system 502, memory 504, the display 506, and other interfaces 508 (e.g., buttons). The memory 504 generally includes both volatile memory (e.g., RAM) and non-volatile memory (e.g., flash memory). An operating system 510 may reside in the memory 504 and be executed by the processing system 502. One or more applications 512, such as the local climate controller 104 or workload manager 126 of FIG. 1 may be loaded in the memory 504 and executed on the operating system 510 by the processing system 502.

The processing device 500 includes a power supply 516, which is powered by one or more batteries or other power sources and which provides power to other components of the processing device 500. The power supply 516 may also be connected to an external power source that overrides or recharges the built-in batteries or other power sources.

The processing device 500 includes one or more communication transceivers 530 and an antenna 538 to provide network connectivity (e.g., a mobile phone network, Wi-Fi®, BlueTooth®). The processing device 500 may also include various other components, such as a positioning system (e.g., a global positioning satellite transceiver), one or more accelerometers, one or more cameras, an audio interface (e.g., a microphone 534, an audio amplifier and speaker and/or audio jack), and storage devices 528. Other configurations may also be employed. In an example implementation, a mobile operating system, various applications and other modules and services may be embodied by instructions stored in memory 504 and/or storage devices 528 and processed by the processing system 502. The memory 504 may be memory of host device or of an accessory that couples to a host.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

(A1) According to a first aspect, some implementations include a method, using one or more computing devices, of locally controlling a climate within a processing device. The method includes determining a device-internal environmental condition for the processing device and initiating a workload on the processing device responsive to determining that the device-internal environmental condition satisfies predefined criteria indicative of a hardware safety risk. The method of A1 is advantageous because initiation of the workload generates local heat that warms the processing device and may also dry the local environment to prevent condensation from forming on internal device surfaces when a risk of condensation is high, such as due to hot and humid conditions.

(A2) In some implementations of A1, the device-internal environmental condition is a relative humidity internal to the processing device and the method further includes determining a temperature internal to the processing device. The temperature and the relative humidity collectively satisfying the predefined criteria when the relative humidity exceeds a first threshold and the temperature exceeds a second threshold. The method of A2 is advantageous because it allows for initiation of the workload at precise times when the condensation risk is high, thereby mitigating power that is expended to protect the processing device from damage associated with condensation.

(A3) In some implementations of A1 or A2, determining the device-internal environmental condition for the processing device further comprises determining a temperature internal to the processing device, wherein the temperature satisfies the predefined criteria when the temperature is below a lower bound of a predefined range of safe operational temperatures for the processing device. The method of A3 is advantageous because it allows for initiation of the workload as precise times when the risk of damage due to extreme temperature is high, thereby mitigating power that is expended to protect the processing device from damage associated with extreme temperature.

(A4) In some implementations of A1, A2, or A3, the initiated workload is a non-critical workload (e.g., user data is not modified by the workload). The method of A4 is advantageous because it reduces a risk of damage to the user data in limited scenarios where the initiated workload is insufficient to protect the processing device from damage attributable to adverse environmental condition(s).

(A5) In some implementations of A1-A4, the method further provides for comparing the device-internal environmental condition for the processing device to a corresponding ambient environmental condition for an environment external to the processing device and initiating the workload responsive to determining that the device-internal environmental condition and the ambient environmental condition satisfy similarity criteria. The method of A5 is advantageous because it provides a mechanism for verifying that the hardware safety risk actually exists and is not, for example, falsely identified based on unreliable sensor data.

(A6) In some implementations of A1-A5, the method further provides for determining, while the workload is executing, an ambient environmental condition external to the processing device and for terminating the workload responsive to determining that the ambient environmental condition does not satisfy the predefined criteria indicative of the hardware safety risk. The method of A6 is advantageous because it allows power to be preserved by way of workload termination once it is known that the hardware safety risk no longer exists due because the ambient environment has changed.

(A7) In some implementations of A1-A6, the processing device is an idle device and the method further provides for identifying an active processing device for which the device-internal environmental condition is not indicative of the hardware safety risk. In response to the identification of the active processing device, the workload is transferred from the active processing device to the idle device. The method of A7 is advantageous because it allows the processing device to be protected from adverse environmental condition(s) by executing a workload that was already scheduled to execute elsewhere on a local network, such as in another cluster of a same data center. Since the workload executed was already scheduled to execute, no additional power is expended to protect the processing device in excess of the power that was planned to be expended to support nominal processing operations.

In another aspect, some implementations provide a local climate control system for a processing device. The local climate control system includes hardware circuitry that executes instructions to perform any of the methods prescribed herein (e.g., methods A1-A7). In yet another aspect, some implementations include a computer-readable storage medium for storing computer-readable instructions. The computer-readable instructions, when executed by one or more hardware processors, perform any of the methods described herein (e.g., methods A1-A7).

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A method comprising:
determining a device-internal environmental condition for a processing device; and
initiating a workload on the processing device responsive to determining that the device-internal environmental condition satisfies predefined criteria indicative of a hardware safety risk.

2. The method of claim 1, wherein the device-internal environmental condition is a relative humidity internal to the processing device and the method further comprises:
determining a temperature internal to the processing device, the temperature and the relative humidity collectively satisfying the predefined criteria when the relative humidity exceeds a first threshold and the temperature exceeds a second threshold.

3. The method of claim 1, wherein determining the device-internal environmental condition for the processing device further comprises determining a temperature internal to the processing device, wherein the temperature satisfies the predefined criteria when the temperature is below a lower bound of a predefined range of safe operational temperatures for the processing device.

4. The method of claim 1, wherein the workload is non-critical.

5. The method of claim 1, wherein the method further comprises:
comparing the device-internal environmental condition for the processing device to a corresponding ambient environmental condition for an environment external to the processing device;
initiating the workload responsive to determining that the device-internal environmental condition and the ambient environmental condition satisfy similarity criteria.

6. The method of claim 1, further comprising:
determining, while the workload is executing, an ambient environmental condition external to the processing device; and
terminating the workload responsive to determining that the ambient environmental condition does not satisfy the predefined criteria indicative of the hardware safety risk.

7. The method of claim 1, wherein the processing device is an idle device and the method further comprises:
identifying an active processing device for which the device-internal environmental condition is not indicative of the hardware safety risk; and
responsive to the identification, transferring the workload from the active processing device to the idle device.

8. A system for controlling climate in a processing device, the system comprising:
a local climate controller stored in memory and executable by a processing system to monitor one or more device-internal environmental conditions for the processing device; and
a workload manager stored in the memory and executable by the processing system to initiate a workload on the processing device responsive when the local climate controller determines that one or more of the monitored device-internal environmental conditions satisfy predefined criteria indicative of a hardware safety risk.

9. The system of claim 8, the one or more device-internal environmental conditions include a relative humidity internal to the processing device and a temperature internal to the processing device, the predefined criteria being satisfied when the relative humidity exceeds a first threshold and the temperature exceeds a second threshold.

10. The system of claim 8, wherein the one or more device-internal environmental conditions include a temperature internal to the processing device, wherein the temperature satisfies the predefined criteria when the temperature is below a lower bound of a predefined range of safe operational temperatures for the processing device.

11. The system of claim 8, wherein the workload is non-critical.

12. The system of claim 8, wherein the local climate controller is further executable to:
compare the one or more device-internal environmental conditions to ambient environmental conditions determined with respect to an environment external to the processing device, wherein the workload manager initiates the workload on the processing device when the local climate controller determines that that the device-internal environmental conditions and the ambient environmental conditions satisfy similarity criteria.

13. The system of claim 8, wherein the local climate controller is further executable to:
determine, while the workload is executing, one or more ambient environmental condition external to the processing device; and
terminate the workload responsive to determining that the one or more ambient environmental conditions do not satisfy the predefined criteria indicative of the hardware safety risk.

14. One or more non-transitory computer-readable storage media encoding computer-executable instructions for executing a computer process, the computer process comprising:
determining a device-internal environmental condition for a processing device; and
initiating a workload on the processing device responsive to determining that the device-internal environmental condition satisfies predefined criteria indicative of a hardware safety risk.

15. The one or more non-transitory computer-readable storage media of claim 14, wherein the device-internal environmental condition is a relative humidity internal to the processing device and wherein the computer process further comprises:
determining a temperature internal to the processing device, the temperature and the relative humidity collectively satisfying the predefined criteria when the relative humidity exceeds a first threshold and the temperature exceeds a second threshold.

16. The one or more non-transitory computer-readable storage media of claim 14, wherein determining the device-internal environmental condition for the processing device further comprises determining a temperature internal to the processing device, and wherein the temperature satisfies the predefined criteria when the temperature is below a lower bound of a predefined range of safe operational temperatures for the processing device.

17. The one or more non-transitory computer-readable storage media of claim 14, wherein the workload is non-critical.

18. The one or more non-transitory computer-readable storage media of claim 14, wherein the computer process further comprises:
comparing the device-internal environmental condition for the processing device to a corresponding ambient environmental condition for an environment external to the processing device;
initiating the workload responsive to determining that the device-internal environmental condition and the ambient environmental condition satisfy similarity criteria.

19. The one or more non-transitory computer-readable storage media of claim 14, wherein the computer process further comprises:
determining, while the workload is executing, an ambient environmental condition external to the processing device; and
terminating the workload responsive to determining that the ambient environmental condition does not satisfy the predefined criteria indicative of the hardware safety risk.

20. The one or more non-transitory computer-readable storage media of claim 14, wherein the processing device is an idle device and the computer process further comprises:
identifying an active processing device for which the device-internal environmental condition is not indicative of the hardware safety risk; and
responsive to the identification, transferring the workload from the active processing device to the idle device.
